(19) United States
(12) Patent Application Publication
(10) Pub. No.: US 2007/0205158 A1
(43) Pub. Date: Sep. 6, 2007

(54) Water conditioner device

(76) Inventors: Liam Shanahan, Irving, CA (US); Paul Donahue, Corona Del Mar, CA (US)

Correspondence Address: FISH & RICHARDSON, PC, P.O. BOX 1022, MINNEAPOLIS, MN, 55440-1022, US

(21) Appl. No.: 11/370,248

(22) Filed: Mar. 6, 2006

(51) Int. Cl. C02F 1/48

(52) U.S. Cl. 210/695; 210/222; 204/557; 366/273

(57) ABSTRACT

A water treatment device. High power magnets are pressed against one another against one another, with like poles facing one another, to form alternating poles. Water is passed through the alternating polarity magnetic field. The water is kept in contact with the field for a time that induces a potential into the water, e.g., for 400 ms. Billing for the system is also disclosed.

### BACKGROUND

All plant life needs water in order to grow and flourish. It is desirable to reduce the amount of water which is used for irrigation. Irrigation may be used for home gardening, as well as commercial purposes such as golf courses and commercial farming.

Various water additives are known which allow irrigation water to be used more effectively.

### SUMMARY

The present application describes a technique of treating water in a way that allows the water to be used more effectively for a variety of purposes, including irrigation.

According to one aspect, this device changes the water in a way that makes it less likely to require chemicals or additives to treat water for irrigation, or to reduce soil compaction to desirable levels through irrigation with the treated water.

Aspects are disclosed for forming a special device for treating water using magnets, the way that the water is treated using the magnets, and timing of the treatment.

### BRIEF DESCRIPTION OF THE DRAWINGS

These and other aspects will now be described in detail with reference to the accompanying drawings, wherein:

FIG. 1 shows a diagram of the system and how it is used;

FIG. 2 shows a diagram of the treatment apparatus;

FIG. 3 shows a diagram of assembly and spacing of the core magnets;

FIG. 4 shows a cross section illustrating vanes used to induce turbulence in the water;

FIG. 5 shows a press technique of forming the center cylinder; and

FIG. 6 shows a technique of welding shut the center cylinder.

### DETAILED DESCRIPTION

The general structure and techniques, and more specific embodiments which can be used to effect different ways of carrying out the more general goals, are described herein.

According to an aspect, irrigation water is electrically charged and treated by passing the water through a chamber is exposed to very powerful and alternating magnetic fields for a specified time, described herein as “the contact period”. In an embodiment, the fields are produced by opposite-polarity magnets that are maintained under extreme pressure with each other and hermetically sealed against the water being treated. In an embodiment, the magnets are 6″ magnets, having values of 12000-14000 gauss, pressurized against each other and resisting each others' charges, at 3000 pounds per square inch. The magnets are sealed within the chamber, and the water is passed through that chamber, preferably around the outside of the sealed magnetic part. The water is then used for irrigation after passing through the chamber.

Others have suggested treating water with magnets. However, those attempts have been different than the disclosed techniques. First of all, many of the treatment techniques eventually clog from the sediment and other substances in the water. The magnets also are not sized the same as discussed herein. Many of the suggestions of using such magnets have also attempted to use the magnets to effect the surface tension of the water. The present application suggests inducing an electrical charge into the water of at least 100 mV, more preferably at least 400 mV. The contact period is adjusted to induce that amount of potential into the water.

The inventors postulate that the water is changed in a similar way to that which occurs to water during a thunderstorm. Water from a thunderstorm produces a better irrigation result, as compared with water which is presented from a variety of sources including Potable water, well water, and reclaimed water. While there are many differences between water which is typically used for irrigation and rain water, an important difference is the introduction of an electrical charge into rainwater by its transit through varying temperature zones in the stratosphere as it falls to earth. The inventors believe that this small electrical charge induced in rainwater effectively controls the salts and minerals in water in a manner which is superior to other forms of water, for growing healthy plants, grass, and crops. This small electrical charge seems to also relieve and reduce binding salts which in turn create highly compacted soil and which in turn requires more water for irrigation by causing a greater percentage of the irrigation water to runoff rather than penetrate the soil.

The embodiment may replicate many of the benefits of rainwater through normal irrigation by similarly inducing a small electrical charge into irrigation water. Thus the embodiment works similar to a hydroelectric generator which effectively utilizes the energy in the flowing water as it passes through highly compressed and varying magnetic flux fields. The time of contact between the water and the magnets is important, to induce the correct and necessary charge into the flowing water to then reduce the amount of water required for irrigation of healthy grass, plants, and crops.

A byproduct of the embodiment is a reduction in the amount of electricity used to run the pumps which deliver irrigation water. A reduction in fertilizers also occurs as a result of utilizing this embodiment, because the charged water more effectively maintains the minerals in solution, allowing the plants and grass to assimilate these minerals more readily. Another observed benefit is that induced charge also maintains salts in solution and reduces those salts from bonding with soils in a manner which increases compaction. When using this device to treat irrigation water, high density soil compaction has been observed to begin to release during the course of normal irrigation over 30-90 days.

Reclaimed water is increasingly being used for irrigation as grass, plants, and crops compete with human consumption of scarce water resources. Reclaimed water is treated with chlorine and other chemicals to kill bacteria. This high concentration of chemicals is injurious to efficient and healthy plant growth. Use of this device to treat reclaimed irrigation water has also been observed to reduce the side effects associated with using reclaimed water for irrigation.

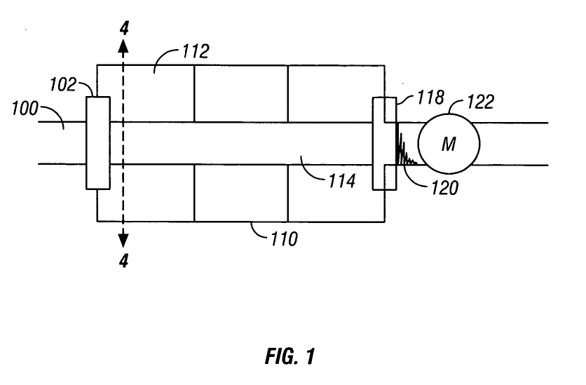

An embodiment is shown in FIG. 1. Water supply 100 may be any kind of conventional water supply, such as a hose of any size, or a water supply pipe with potable water, well water, or reclaimed water. The water is supplied to a water conditioner assembly 110 which includes a water passing chamber 112, through which the water can pass, and a magnetic effect chamber 114. The magnetic effect chamber 114 may include a plurality of high density magnets arranged as described herein, with like polarities of each pair of magnets facing one another, and held under pressure against an adjacent magnet.

The water exits from the chamber 110 at exit point 118, which connects to an outlet supply 120 which, again, may be a hose. The amount of water may be metered by water meter 122.

In one embodiment, the billing for the water operation is based on the amount of water actually treated by the device. In this embodiment, the water meter 122 maintains a running count of the volume of water that has been treated by the device. In another embodiment, the meter may be resettable, to maintain a count of the number of gallons treated since the last reset. The user is then billed according to the number of gallons of water that the device treats prior to user for irrigation. Another embodiment determines billing based on the amount of money that is saved by using the device. The company compares the actual water used by a client against the water which should have or would have been used for that location for the same period. Readings from a meter, representing the amount of water actually used, form one prong of this analysis. The other prong is determined from a measure of the amount of water which is projected to have been used for the location during the same period.

The projection of water usage may be done in different ways. An Evapotranspiration analysis for the given period and location may be used. The Evapotranspiration analysis for a given region in California can be found at the web site http://www.cimis.water.ca.gov. Evapotranspiration can be used to calculate an amount of water that should be or is applied. Alternative methods of calculating the amount of water which would normally be used for a given location and period involve use of the Evapotranspiration calculations are also described on other websites, including http://www.wateright.org/site2/publications/920701.asp.

In an embodiment, a billing method is based on a percentage of the savings obtained from using the device. Savings may include savings of water, electricity to pump the water, and/or of fertilizers and chemicals saved by using the water treatment device of the embodiment. A percentage of the savings, e.g., 50% of any savings, may be used as a billing amount. The savings may be savings of water, electricity, or chemicals.

For water savings, the measured and reduced amount of water required to irrigate the location as a result of the use of the water treatment device is expressed in cumulative amounts saved in units of, for example, gallons, acre feet, and or as a percentage saved. The billing is then derived by determining a savings associated with that amount of water, by finding water cost, cost of electricity for pumping, and or chemicals saved, and using this to derive a total monthly bill.

In an alternative embodiment, the bill for water, electricity for pumping, or chemicals and fertilizer is compared against historical bills for the same period, rather than using a model as in the first embodiment. This method may be less accurate because of weather conditions which vary widely from year to year, however, may be a simpler and more understandable model for billing.

A more accurate version of the historical method can determine the historical Evapotranspiration analysis for the same period and location against actual water used historically. Even this method can be less accurate, because often historical water usage is estimated by the water utility for one or two months and later readjusted every two to three months when the meter is actually read.

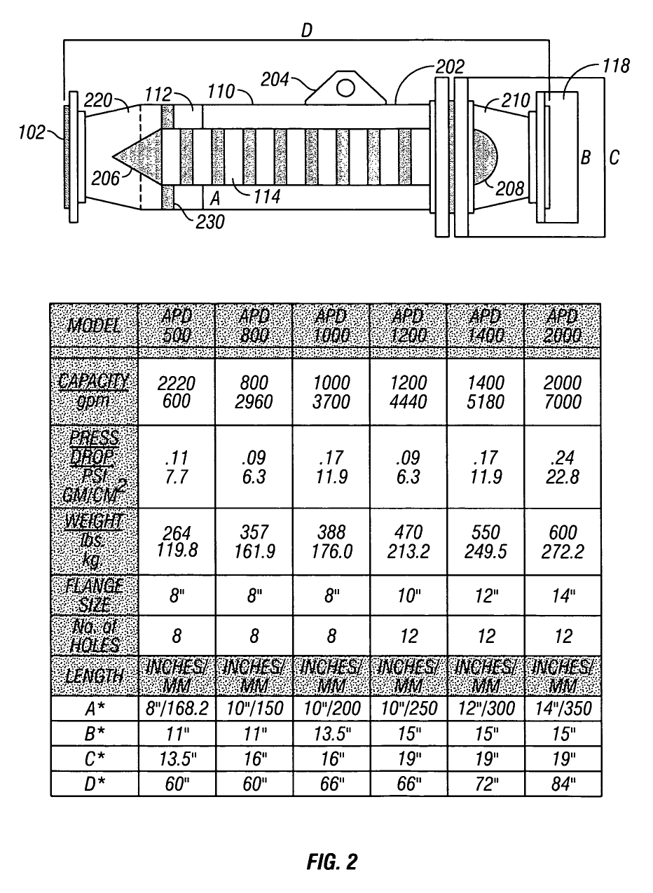

FIG. 2 shows further detail about the water conditioner assembly 110. The assembly 110 has input part 102 which may be a screw thread or any desired other kind of thread. The housing of the water conditioner assembly 110, however, is most desirably formed of stainless steel or carbon steel in order to maintain the proper magnetic effect. The housing itself has a main portion 202 which is basically a stainless steel or carbon steel tube. The tube is coated internally with an epoxy/ceramic paint such as manufactured by Ceramkote, to prevent electrolysis induced by the water flowing through the very high density magnetic flux fields contained within the tube. The tube is also firmly grounded by attaching a ground wire to the tube, and putting a ground wire into the ground. The grounding and coating can resist the negative and corrosive effects of electrolysis.

Connecting portion 204 is connects to the stainless steel tube and may allow mounting of the device on a cart or in a permanent installation. The inside chamber 112 includes a water treatment part 114 therein. The water treatment part has a substantially beveled presentation part 206. The input water is distributed coaxially around the treatment part by this input surface. The water then travels through the chamber 112, until it reaches the end portion 208.

The end portion 208 includes a substantially convex rounded surface 208 to create turbulence, helping the water to mix in the mixing chamber 210.

Two tapered areas are provided: a first area 220 which increases the diameter of the tube from the opening area 102 to the increased diameter area of the chamber 112. A second area 210, within the mixing chamber, reduces the area down back to the original area of the hose at 118.

One embodiment uses one or more fixed vanes, shown in FIG. 4, which illustrates a cross section along the line 4-4 in FIG. 1. The vanes 401, 402, 403, 404 are tilted to cause the water to spiral in the direction of the arrow 405 (clockwise). The spiraling can be from the entrance of the tube to its exit. This spiraling causes the water to spend increased time passing through the very high density and alternating flux fields.

FIG. 2 shows some exemplary dimensions, labeled A, B, C, and D. Notably, dimension A refers to the diameter of the chamber 112, and dimension D refers to the overall length of the unit. The different units with their model numbers, and capacity, both in gallons per minute and liters per minute, are shown in table 1

TABLE 1

| | Model | | | | | |
|---|---|---|---|---|---|---|
| | APD | APD | APD | APD | APD | APD |
| | 600 | 800 | 1000 | 1200 | 1400 | 2000 |
| Capacity | | | | | | |
| gpm | 600 | 800 | 1000 | 1200 | 1400 | 2000 |
| lpm | 2220 | 2960 | 3700 | 4440 | 5180 | 7000 |
| Press | | | | | | |
| Drop | | | | | | |
| PSI | .11 | .09 | .17 | .09 | .17 | .24 |
| CM/CM2 | 7.7 | 6.3 | 11.9 | 6.3 | 11.9 | 22.8 |
| Weight | | | | | | |
| lbs. | 264 | 357 | 388 | 470 | 550 | 600 |
| kg | 119.8 | 161.9 | 176.0 | 213.2 | 249.5 | 272.2 |
| Flange | 8″ | 8″ | 8″ | 10″ | 12″ | 14″ |
| Size | | | | | | |
| No. of | 8 | 8 | 8 | 12 | 12 | 12 |
| Holes | | | | | | |
| Length | Inches/MM | Inches/MM | Inches/MM | Inches/MM | Inches/MM | Inches/MM |
| A* | 8″/168.2 | 10″/150 | 10″/200 | 10″/250 | 12″/300 | 14″/350 |
| B* | 11″ | 11″ | 13.5″ | 15″ | 15″ | 15″ |
| C* | 13.5″ | 16″ | 16″ | 19″ | 19″ | 19″ |
| D* | 60″ | 60″ | 66″ | 66″ | 72″ | 84″ |

Because of the very high density of the varying flux fields which is intersected by the flow of water, which in most cases contains minerals and salts, a voltage is induced into the water. This is analogous to the way that a hydropower generator induces a voltage into wires. This process creates electrolysis within the device. It was found that this damaged the welds and steel used to manufacture the devices. Coating with an electrically insulating dielectric material, e.g., a ceramic and/or epoxy, and a solid ground wire to earth ground, can be used.

The specific materials and methods which are used to form, coat, and install the assemblies may be very important. The assemblies may be formed of T410 stainless steel or carbon steel body, T304 stainless steel reducers at 210 and 220 or carbon steel, and the flanges may be also formed of T304 stainless steel or of carbon steel. In both instances the devices are coated internally with a magnetically inert, electrically insulating dielectric material to prevent electrolysis from eroding the integrity of the metal and welds while allowing the magnetic fields to be properly configured. A mixture of epoxy and ceramic paint can be used to provide this installation for all internal components of the devices. In addition to this dielectrically insulating material the units are substantially electrically connected to a solid ground or earth connection.

The flanges include flanges at areas 102 and 118. The water treatment device 114 is held in place by retainer rods, shown generally as 230, but it is understood that there may be more than simply one retainer rod. The retainer rods may be 1 inch T304 stainless steel. The body may be any length, but the length is selected to subject the flowing water to the high density and varying magnetic fields for greater than 400 milliseconds. Therefore the proper length of the device can be determined, based on the velocity of the water in ft per second and setting the length of the water conditioning tube at long enough to insure that the water remains in the device for 400 milliseconds or longer.

In a straight tube which does not have internal vanes to lengthen the transit time through the high density flux fields, an example is water velocity of 8 ft/sec and a required treatment transit time of 400 milliseconds yields a device which is 44 inches long, and formed of T410, 3/16″, stainless steel or carbon steel. Appropriate reduction of the length of the tube by 20% or some other value, set according to the amount of increased contact.

As a part of the initial installation and ongoing service, a test is made to insure that the device is working properly and effectively treating water for irrigation purposes. The test comprises measuring the voltage which has been induced into the flowing water by the device. It has been found important to make this measurement with a very high impedance voltmeter, which has an impedance of not less than 25 million ohms per volt, even better an impedance of 50 million ohms per volt for greater accuracy. Any device that has a lower impedance causes the device to become part of the circuit, and may impede proper measurement.

A device is found to be working properly for irrigation purposes when a DC voltage of not less than 100 millivolts is measured in the water with a probe, as it flows past the probe or after it has been treated and collected in a 10 gallon container. More preferably, the DC voltage should be not less than 400 mv. The high impedance voltmeter used for this confirmation and test must be properly and effectively grounded.

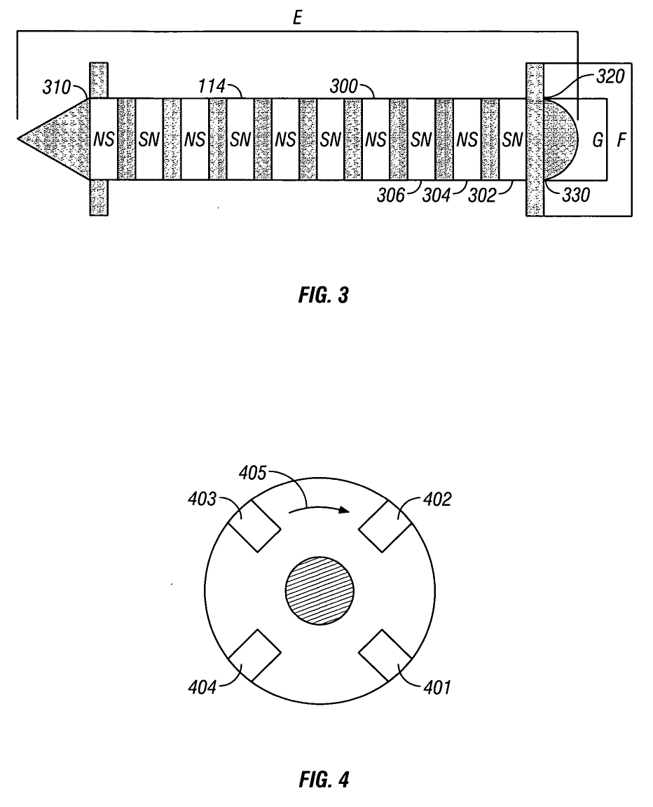

Further details of the core assembly 114 are shown in FIG. 3. FIG. 3 also shows some exemplary measurements for the core assembly 114. The core assembly 114 is formed of an outer housing 300 which is hollow and preferably cylindrical. A plurality of magnets such as 302, 304 are installed within the housing. Each magnet is installed under very high pressure, e.g., 3000 pounds per square inch, with like poles facing one another. That is, the magnet 302 has its south pole facing towards the south pole of the adjacent magnet 304. The magnet 304 correspondingly is installed with its north pole facing the corresponding north pole of the next magnet 306. In this way, each magnet repels each adjoining magnet and creates enormous kinetic energy and very powerful and alternating flux fields. As the water flows past the flux fields, the fields appear to be varying from the perspective of that flowing water.

This manufacturing method of “compressing” the spacing between alternating pole magnets increases the flux density within the treatment tube to levels necessary to treat the flowing water with results which are repeatable in a variety of locations and with a variety of water sources which can include potable water, well water, or reclaimed water. The housing also includes stainless steel disks 310 and 320 closing the ends of the housing.

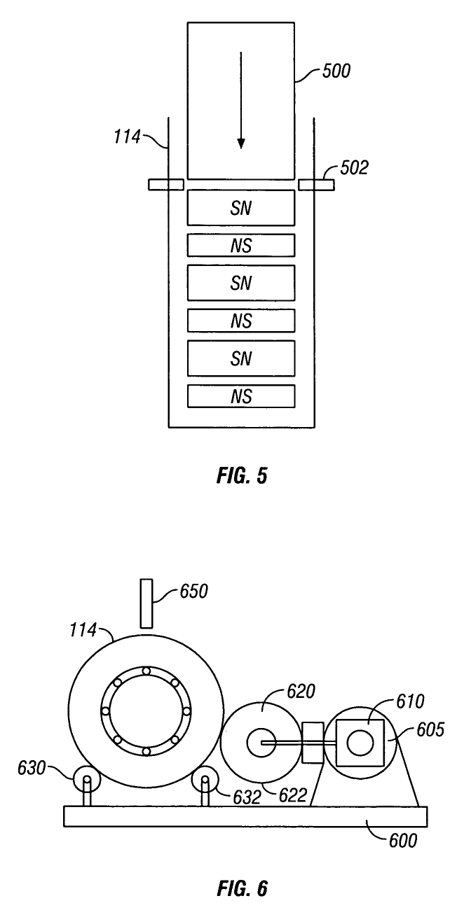

To form the device, FIG. 5 shows a hydraulic ram 500 compressing the magnets to a specified pressure. For example, the ram may compress the magnets to 3000 pounds per square inch with a spacing distance of 1¼ inches from each magnet. Once compressed, one or more pins 502 may be placed to hold the magnets in place. The ends may then be welded shut, to close and waterproof the energy core. The energy core is coated with a magnetically inert, electrically insulating dielectric coating such as the epoxy and ceramic mixture which coats the inside of the tube.

FIG. 6 illustrates a device which may be used to improve the welding/sealing. Platform 600 is formed with a motor 605. The motor has a first reducer 610, and a second reducer 620. Both of these reducers may be formed by, for example, gears or pulleys which reduce the RPM output from the motor 605. The second reducer 620 has an elastomeric, e.g. rubber, outer surface which can cause frictional press against the outer surface of the tube 114. The tube 114 is located on Barings 630, 632. The outer surface of reducer 620 causes the tube 114 to rotate very slowly. A welding device 650 is operated adjacent to the opening, and welds shut the case as it rotates. By rotating the tube slowly, a very consistent weld may be obtained.

In one embodiment, the core may have a length B of 55 inches which is determined by the above calculation for a given water velocity and the need to establish a transit time for the flowing water of not less than 400 milliseconds through the treatment process, a diameter G of 6 inches, and may use a number of 6 inch by 2.032 NdFeB N50 nickel coated magnets. We expect to develop internal flux density fields of no less than 4500 gauss and up to 8500 gauss using the methods and materials described herein.

In another embodiment, directional flow fins may be added to create a tighter water vortex around the core thereby increasing the transit time of the water within the high density flux fields as defined above for treatment of irrigation water

In operation, water passes through the chamber prior to use for irrigation.

Although only a few embodiments have been disclosed in detail above, other embodiments are possible and the inventor intends these to be encompassed within this specification. The specification describes specific examples to accomplish a more general goal than may be accomplished another way. This disclosure is intended to be exemplary, and the claims are intended to cover any modification or alternative which might be predictable to a person having ordinary skill in the art. For example, this may be used for other applications besides just irrigation. Also, while the above describes the material being stainless steel, it should be understood that other materials could be used; e.g., any material that allows magnetic effects to be introduced to the flowing water can be used. The energy core must be made of magnetically inert material, yet the exterior tube of the device is preferably of or surrounded by a magnetic material to fully contain and further compress the flux field.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A method comprising:
forming a very high powered and completely contained alternating magnetic flux field in a chamber that alternates between north pole and south pole, along a direction of travel of water;
passing a flow of water through the chamber, so that the water comes into contact with the magnetic field in the chamber for an amount of time that is effective to form a measurable potential in the water.

2. A method as in claim 1, wherein said passing comprises forming an input area which connects to an input supply of water, and forming an output area which connects to an output supply of water.

3. A method as in claim 2, wherein said input area includes a first surface which promotes water passing coaxially around said magnetic field.

4. A method as in claim 3, wherein said output area includes a second surface which promotes water mixing after said coaxially passing.

5. A method as in claim 1, wherein said forming a magnetic field comprises forming a plurality of magnets which have like poles facing one another, and which are pressed against one another with a specified amount of pressure.

6. A method as in claim 5, wherein said chamber is formed of a material that allows magnetic field to pass therethrough.

7. A method as in claim 1, wherein said amount of time is 400 ms through a magnetic field having a magnitude greater than 4500 Gauss and that alternates in polarity.

8. A method as in claim 1, wherein said amount of time is an amount of time that forms a potential greater than 100 mV measured with a high impedance voltmeter.

9. A method as in claim 1, wherein said amount of time is an amount of time that forms a potential greater than 400 mV measuring with a high impedance voltmeter.

10. A method as in claim 1, wherein said forming comprises pressurizing a plurality of disk shaped magnets against one another, with opposite poles facing one another.

11. A method as in claim 10, wherein said pressurizing comprises pressurizing the magnets to a force of 3000 pounds per square inch or higher.

12. A method as in claim 1, further comprising coating the chamber with a magnetically inert and electrically insulating material.

13. A method as in claim 12, further comprising grounding the chamber to an earth ground.

14. A method as in claim 1, further comprising forming a spiral flow in said water.

15. A method, comprising:
forming an alternating magnetic field, using a plurality of magnets which have a like poles facing one another, and are pressurized, to resist the force of said like poles facing one another;
passing a flow of water past said plurality of magnets, in a direction where flow of the water causes the water to first pass one pole and then pass another of said poles; and
agitating at least one portion of the water to form turbulence in said at least one portion.

16. A method as in claim 15, wherein said alternating magnetic field comprises at least 4500 Gauss.

17. A method as in claim 15, wherein said alternating magnetic field comprises at least 12,000 gauss.

18. A method as in claim 16, wherein said passing comprises maintaining the water in contact with them alternating magnetic field for at least 400 ms.

19. A method as in claim 16, wherein said passing comprises maintaining the water in contact with said alternating magnetic field for a time that is effective to induce a voltage of at least 100 mV into said water, said voltage being one which is measurable using a high impedance volt meter.

20. A method as in claim 15, further comprising encasing the alternating magnetic field within a casing.

21. A method as in claim 20, further comprising protecting the casing using a material which is electrically insulating and magnetically inert.

22. A method as in claim 21, wherein said material includes epoxy.

23. A method as in claim 21, further comprising grounding the case.

24. A method as in claim 15, further comprising using the treated water for irrigation.

25. An apparatus, comprising:
an inner casing, formed of the material that allows magnetic effects to pass therethrough;
a plurality of magnets, each having a magnetic value greater than 4500 Gauss, loaded into said casing, having opposite polarity poles facing against one another, and under pressure within the casing; and
an outer casing, surrounding said inner casing, and having a connection which allows water to be passed therethrough.

26. An apparatus as in claim 25, wherein said inner casing is completely sealed with said magnets therein.

27. An apparatus as in claim 25, wherein said inner casing has a size and length which is effective to maintain the water between said inner and outer casing for at least 400 ms.

28. An apparatus as in claim 25, wherein said inner casing has a size and length which is effective to maintain the water between said inner and outer casing for a time that is effective to form a measurable potential in said water.

29. An apparatus as in claim 28, wherein said measurable potential is at least 100 mV.

30. An apparatus as in claim 28, wherein said measurable potential is at least 400 mV.

31. An apparatus as in claim 25, further comprising at least one device which induces turbulence into a flow of water.

32. An apparatus as in claim 31, wherein said at least one device is coupled to a leading surface of said inner casing.

33. An apparatus as in claim 31, wherein said at least one device is a fin which causes the water to spiral.

34. An apparatus as in claim 25, further comprising a protective coating on at least one of said casings, said protective coating being electrically insulating and magnetically inert.

35. An apparatus as in claim 34, wherein said protective coating includes epoxy.
